(19) United States
(12) Patent Application Publication
(10) Pub. No.: US 2003/0234851 A1
(43) Pub. Date: Dec. 25, 2003

(54) Inkjet printing method and apparatus

(76) Inventors: Andrew J. S. Booth, Qualicum Beach (CA); Darcy Thomas Montgomery, Burnaby (CA); Isabelle Fusey, Vancouver (CA); David Scott Bruce, Delta (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/347,330

(22) Filed: Jan. 21, 2003

Related U.S. Application Data
(60) Provisional application No. 60/349,266, filed on Jan. 18, 2002.

(51) Int. Cl. B41J 2/01

(52) U.S. Cl. 347/104

(57) ABSTRACT

Inkjet printers are optimized for high printing throughput by dimensioning the media-carrying surface to have dimensions marginally larger than the size of one or more maximum-size standard print media sheets. The print media sheets used in conjunction with the media-carrying surface are selected from among standard sheets that exhibit certain geometrical properties and have sizes less than or equal to that of the maximum-size sheet. Drum-based and flatbed inkjet printers are provided with media-carrying surfaces dimensioned according to the invention.

### REFERENCE TO RELATED APPLICATION

This application claims the benefit of the filing date of U.S. Provisional Application No. 60/349,266, filed Jan. 18, 2002.

### TECHNICAL FIELD

This invention relates to the field of inkjet printing and to carriers for inkjet print media. The invention has particular application to inkjet printing devices in which print media are supported on a rotatable drum.

### BACKGROUND

Conventional inkjet printers are well known in the art. A serial inkjet printer has a plurality of inkjet nozzles contained in a printhead mounted on a moveable carriage. In general, a printhead may be any array of nozzles. Some printheads may comprise more than one printhead unit. For example, a printhead may comprise two heads mounted side by side (or staggered) to form a larger printhead. The carriage typically moves the inkjet printhead in a generally linear manner across a print medium (e.g. a paper sheet) by translating the printhead in a first “trace” direction and then retracting the printhead in a “retrace” direction. The print medium is also advanced in a direction perpendicular to the direction of motion of the printhead. In this manner, an image may be imparted over the entire printable surface of the print medium by advancing the print medium in a first direction and repeatedly passing the printhead over the print medium in the trace and retrace directions. Inkjet printers incorporating this type of architecture are referred to in this description as “serial” inkjet printers.

A common problem experienced when using serial inkjet printers for color printing relates to mixing, coalescing and/or shape deformation between ink droplets of various colors. These phenomena typically occur on the print medium, when the ink droplets are still in liquid form (i.e. not yet dry) and when the ink droplets are deposited in close proximity to one another. In these circumstances, liquid ink droplets may coalesce or mix with one another and/or deform in shape. Such coalescing, mixing or shape deformation may have a significant impact on the appearance of a resulting image. For example, because of color mixing, the appearance of an image may depend on the order that different colored inks are applied. Coalescing, mixing and shape deformation of ink droplets may also distort the appearance of monochromatic images where only one color of ink is used.

For high quality printing, it is necessary to minimize coalescing, mixing and shape deformation of ink droplets. Serial inkjet printers typically have high quality modes in which printing is performed only when the printhead carriage is travelling in a single direction. In these modes, the nozzles in the printhead are activated only when the printhead is moving in the trace direction and are not activated when the printhead is moving in the retrace direction. This results in a relatively low print throughput. The time during which the printhead is moving in the retrace direction and the inkjet nozzles are not activated is referred to as “dead time”. It has long been a desire in the inkjet printing industry to increase printing throughput by minimizing dead time. Although many serial inkjet printers provide a “draft” printing mode, where printing occurs in both the trace and retrace directions, the printing quality achieved in draft mode is typically poor.

Inkjet printers having drum architectures have been suggested to help overcome the print throughput limitation associated with serial inkjet printers. In drum-based printers, a cylindrical drum carries the print medium on its circumferential surface. A printhead is positioned adjacent to the drum's circumferential surface and oriented such that its nozzles face the print medium. The media-carrying drum rotates about its axis.

A common drum-based printer architecture, referred to as a “partial width array”, comprises an inkjet printhead that is small in comparison to the axial width of the print medium. A moveable carriage supports the printhead and translates the printhead relative to the drum by tracing and retracing the printhead in directions parallel to the drum axis. A partial width array inkjet printer imparts an image onto the entire surface of the print medium by ejecting ink droplets onto the print medium while translating the printhead in directions parallel with the drum axis and simultaneously rotating the drum about its axis. The printhead may make multiple passes over the same region of the print medium during successive revolutions of the drum about its axis.

Another common drum-based printer architecture, referred to as a “page-wide array”, comprises an inkjet printhead that is sufficiently large (i.e. in a direction parallel with the drum axis) to cover the entire axial width of the print medium. Because of its width, the page-wide array printhead need not translate in the direction of the drum axis to apply ink over the entire width of the print medium. A page-wide array printer imparts an image onto the entire surface of the print medium by ejecting ink droplets over the full axial extent of the print medium while simultaneously rotating the drum about its axis. The printhead may make multiple passes over the print medium during successive revolutions of the drum about its axis. The printhead may translate in the direction of the drum axis to interleave ink droplets expelled during successive passes.

In general, drum-based inkjet printers can be designed so that the nozzles of the printhead can expel ink droplets whenever the printhead is aligned with the print medium. The only dead time during which the inkjet nozzles of a drum-based printer can not expel ink occurs when the printhead is aligned over the gap between the leading and trailing edges of the print medium (i.e. the “dead space”). Accordingly, drum-based inkjet printer architectures can significantly improve the printing throughput of high quality inkjet printing (relative to serial inkjet printers).

The most common inkjet printing medium is paper. U.S. Pat. No. 5,771,054 to Dudek et al. describes a drum-based inkjet printer, wherein the drum is sized to accommodate paper sheets of letter size, legal size and European sizes such as A4. U.S. Pat. No. 6,070,977 to Nuita et al. describes a drum-based inkjet printer having a drum width of about 200 mm and a circumference of 408 mm, allowing the drum to carry A4 or larger size paper sheets. U.S. Pat. No. 6,154,232 to Hickman et al. discloses another drum-based inkjet printer, wherein the drum may be a variety of sizes, but is preferably around 50 cm in circumference. All of these patents provide a drum with a circumferential surface which can accommodate one specific paper size or a variety of paper sizes.

From a flexibility perspective, inkjet printers having drums that accommodate multiple paper sizes are preferable over inkjet printers having drums configured for a specific paper size. However, from a cost and complexity perspective, printers having drums equipped to support a variety of different paper sizes (possibly in different orientations) require expensive and complex fastening systems to fasten the various sizes of paper sheets to the drum. Printers having drums equipped to support a variety of different paper sizes also suffer a speed disadvantage when printing on any size of paper other than the maximum size paper that the drum is able to support. This speed disadvantage occurs because a relatively large drum that supports a relatively small sheet of paper will have more dead time, wherein the printhead is positioned over the relatively large gap between the leading and trailing edges of the paper and the inkjet nozzles cannot be activated.

For desktop or office printers, a trade-off between speed and flexibility may be reasonable, such that printers accommodating multiple sheet sizes may be preferable. However, for high productivity printing presses, where printing throughput is critically important, such a trade-off may be unacceptable.

Inkjet printers having a flatbed architecture have recently emerged, primarily for printing on relatively rigid print media such as cardboard. Flatbed printers comprise a substantially flat media-carrying surface. The printhead and the print medium move relative to one another in one or more orthogonal directions to image the entire printable region of the print medium. The relative motion between the printhead and the print medium may be effected by moving the printhead, the print medium or a combination of both. As with drum-based printers, flatbed inkjet printers may be constructed with partial width array or page-wide array printhead architectures.

The medium carrying surface of a flatbed printer may be sized to accommodate a variety of different paper sizes. As with drum-based printers, the fastening systems required to accommodate a variety of paper sizes on a flatbed printer increase the printer's cost and complexity. In a flatbed architecture, however, the printhead only traverses the area of the paper and there is no dead space where the printhead is not aligned with the print media. Consequently, when the media-carrying surface is sized to accommodate multiple paper sizes, flatbed printers do not necessarily suffer from the same speed disadvantage that plagues drum-based printers.

However, when the media-carrying surface is sized to accommodate multiple paper sizes and the paper being printed on is smaller than the full width of the printhead, page-wide array flatbed printers may have a number of redundant nozzles. If smaller size sheets are predominantly used in the printer, the largely redundant nozzles represent additional cost for little benefit. Furthermore, unused inkjet nozzles have a tendency to block or clog more often than nozzles that are frequently active. It is quite probable that such redundant nozzles will need to undergo a maintenance cycle if a user wishes to print a larger sheet. Maintenance cycles typically use ink, further reducing cost effectiveness.

Another problem associated with inkjet printers relates to the fact that ink droplets applied to print media are in liquid form. Liquid ink droplets can damage print media, causing distortion of the resultant image. The tendency of ink droplets to damage print media increases with the number and the density of ink droplets that exist in liquid form on the print media at any given time.

There is a general need for inkjet printing methods and apparatus which increase print quality and improve printing throughput. It is desirable to accommodate at least two commonly used print media sizes without incurring substantial additional hardware cost or complexity.

### SUMMARY OF INVENTION

In accordance with one aspect of the invention, an inkjet printer comprising a media-carrying surface, the media-carrying surface having at least one dimension that is marginally larger than a corresponding dimension of one (or a combined corresponding dimension of more than one) standard-size print media sheet.

In another aspect of the invention, an inkjet printer is provided, the inkjet printer comprising a drum having a media carrying circumferential surface and at least one printhead having a plurality of nozzles directed at the circumferential surface. Ink droplets ejected by the at least one printhead in a first pass are at least partially dried on the surface of the print media prior to applying more ink droplets in successive passes.

The ink droplets may be at least partially dried between successive passes by providing a drum with a sufficiently large circumference that the time between successive passes of the printhead is sufficient for the droplets to at least partially dry on their own. The droplets may be actively dried using drying devices located proximate to the circumferential surface of the drum.

Some embodiments may include multiple printheads and/or multiple drying devices located at circumferentially spaced apart positions around the circumferential surface of the drum. The circumferential surface of the drum may also be heated.

The invention may comprise partial width array printheads or page-wide array printheads.

Further aspects of the invention and features of specific embodiments of the invention are set out below.

### BRIEF DESCRIPTION OF DRAWINGS

In drawings which illustrate non-limiting embodiments of the invention:

FIG. 1 is a schematic depiction of paper sheet sizes commonly used in North America;

FIG. 2A is a schematic diagram showing a media-carrying surface, wherein a single print media sheet is secured to the surface in accordance with the invention;

FIG. 2B is a schematic diagram showing a media-carrying surface, wherein a pair of print media sheets are secured to the surface in accordance with the invention;

FIG. 3A is an isometric view of a drum-based inkjet printer having a page-wide array architecture, wherein a pair of print media sheets are secured to the circumferential surface of the drum;

FIG. 3B is an isometric view of a drum-based inkjet printer having a partial width array architecture, wherein a single print media sheet is secured to the circumferential surface of the drum;

FIG. 4A is an isometric view of a flatbed inkjet printer having a page-wide array architecture, wherein one print media sheet is secured to the flatbed surface;

FIG. 4B is an isometric view of a flatbed inkjet printer having a partial width array architecture, wherein a pair of print media sheets are secured to the flatbed surface;

FIG. 5A is an isometric view of a large circumference drum-based printer accommodating six US D size sheets on a media-carrying surface thereof;

FIG. 5B is an isometric view of a large circumference drum-based printer accommodating three US E size sheets on a media-carrying surface thereof;

FIG. 6 is an isometric view of a drum-based printer incorporating a plurality of circumferentially spaced inkjet printheads; and, FIG. 7 is an end view of a drum-based printer incorporating a plurality of circumferentially spaced inkjet printheads and a plurality of circumferentially spaced drying devices.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

In this description, the terms “print medium” and “print media” are used to describe any sheet-like media on which printing is to take place. Print media may be of different sizes, textures, and compositions and may be flexible, partially rigid, or completely rigid. A common print medium used in inkjet printing is paper. Other print media include cardboard, vellum, polyester films and the like.

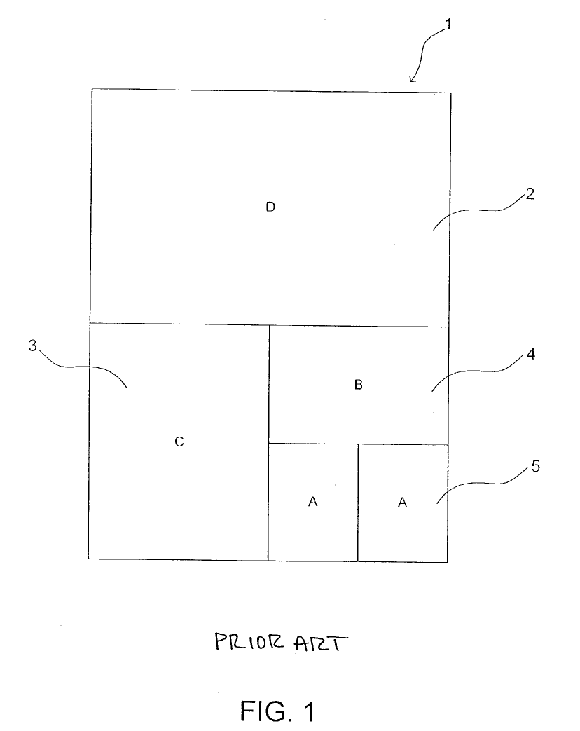

Table 1 lists two series of standard-size paper. Sheets of the metric series shown in the Table 1 are widely used in many countries worldwide. Sheets of the United States (US) series are used predominantly in North America. For both the metric and US series, the sheets progressively halve in size from the largest to the smallest sheet. As can be seen from both Table 1 and the schematic illustration of FIG. 1, an E size sheet 1 folded in half once along its longer dimension is the same size as D size sheet 2. Similarly, an E size sheet 1 folded in half twice (or a D size sheet 2 folded in half once) along its longer dimension is the same size as C size sheet 3. An E size sheet 1 folded in half three times (or a D size sheet 2 folded in half twice or a C size sheet 3 folded in half once) along its longer dimension is the same size as B size sheet 4. Finally, an E size sheet 1 folded in half four times (or a D size sheet 2 folded in half three times or a C size sheet 3 folded in half twice or a B size sheet 4 folded in half once) along its longer dimension is the same size as an A size sheet 5. A similar geometrical relationship exists for the metric sheet sizes listed in Table 1.

TABLE 1

| | |
|---|---|
| United States Sizes | Metric Sizes |

| Name | Size in Inches | Name | Size in Inches |
|---|---|---|---|
| A | 8½ × 11 | A4 | 8.27 × 11.69 |
| B | 11 × 17 | A3 | 11.69 × 16.54 |
| C | 17 × 22 | A2 | 16.54 × 23.39 |
| D | 22 × 34 | A1 | 23.39 × 33.11 |
| E | 34 × 44 | A0 | 33.11 × 46.81 |

Each sheet in the series has an aspect ratio (i.e. a ratio of its longer side to its shorter side) of \sqrt{2}. Any sheet having the \sqrt{2} aspect ratio exhibits the property that when its longer side is cut in half, it produces two smaller sheets which also have the \sqrt{2} aspect ratio and have exactly half the area of the first sheet. Sheets having the \sqrt{2} aspect ratio are referred to throughout this description and in the accompanying claims as “standard” sheets. Given any one standard sheet, a series of standard sheets may be created by successively halving the standard sheet.

In addition to the standard-size sheets shown in Table 1, other series of standard-size sheets are commonly used in the printing industry. For example, standard-size sheets may be made slightly larger than the standard-size sheets of Table 1 where binding space is required.

In accordance with a preferred embodiment of the invention, the geometrical relationship between sheets in a series of standard print media sheets is exploited in a high productivity inkjet printer. Dead time may be minimized and printing throughput may be improved by selecting the media-carrying surface to have at least one of its dimensions marginally larger than a corresponding dimension of one (or the combined corresponding dimensions of more than one) standard print media sheet(s) of a particular series. High efficiencies can then be achieved while printing on print media sheets selected from among the standard sheets of that series.

Throughout this description and in the accompanying claims certain dimensions of media-carrying surfaces are described as “marginally larger” than a corresponding dimension of one (or the combined corresponding dimensions of more than one) print media sheet(s). For example, if a print media sheet has a certain dimension of x centimeters, then a corresponding dimension of a media-carrying surface is marginally larger than the dimension of a single print media sheet if the dimension of the media-carrying surface is marginally larger than x centimeters. The corresponding dimension of the media-carrying surface is marginally larger than the combined dimension of two such media sheets if the dimension of the media-carrying surface is marginally larger than 2x centimeters. A dimension that is “marginally larger” is not more than 10% larger than the dimension to which it is being compared. However, in some embodiments, where a dimension is “marginally larger”, it is preferable that the dimension is not more than 5% or even 2% larger than the dimension to which it is being compared.

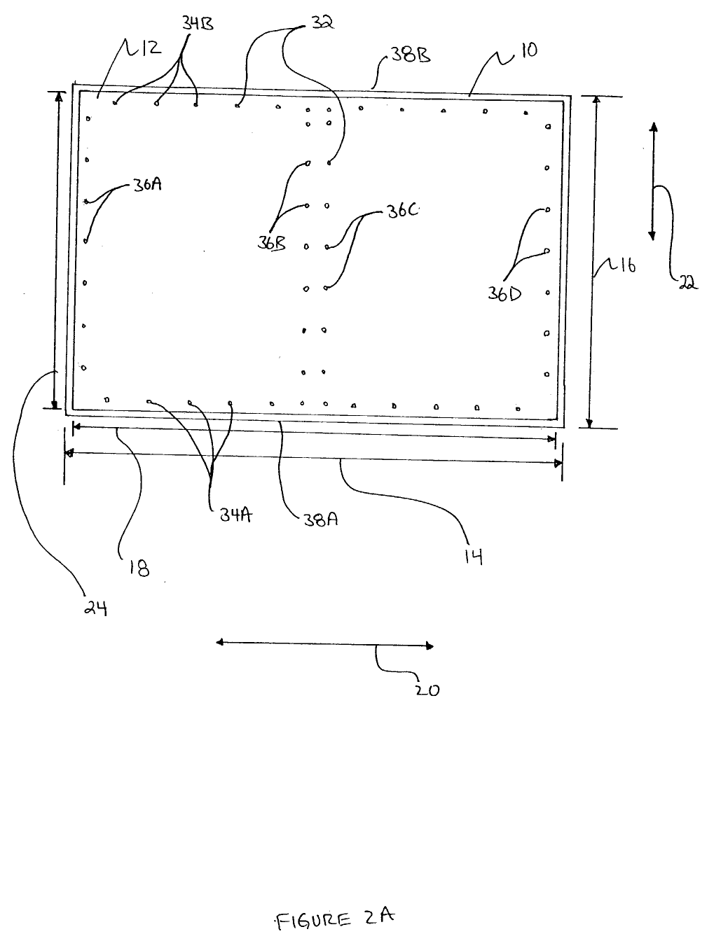

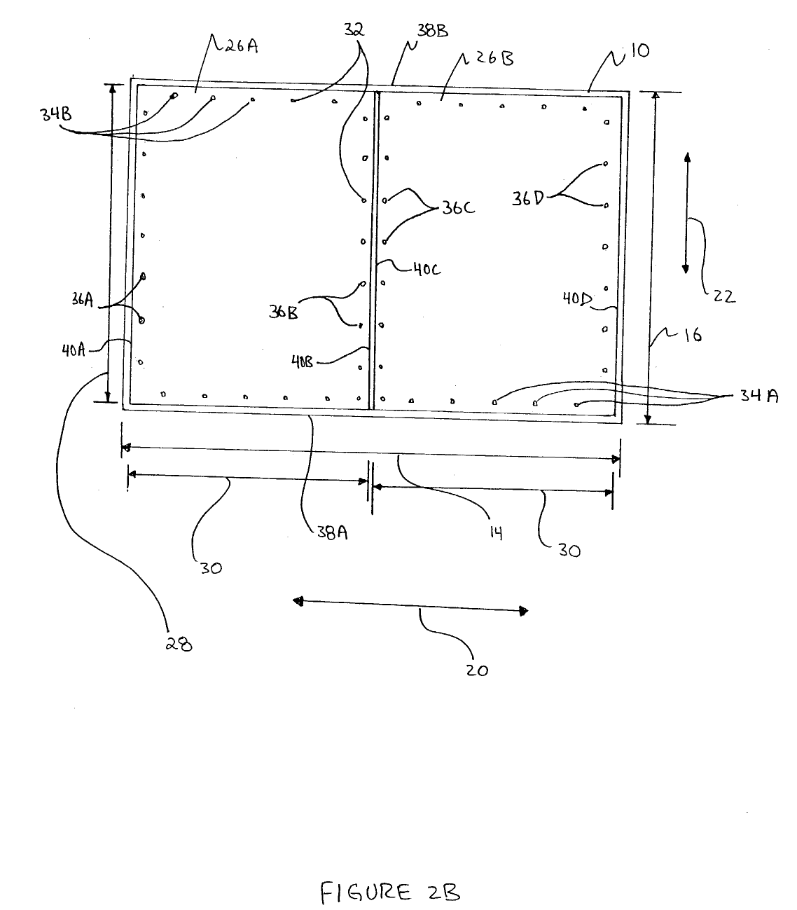

FIGS. 2A and 2B show a representative example of a media-carrying surface 10 in accordance with the present invention. In the illustrations of FIGS. 2A and 2B, media-carrying surface 10 is shown to be flat to better illustrate the principles of the present invention. However, those skilled in the art will appreciate that media-carrying surface 10 may be the circumferential surface of a cylindrical drum.

For the purposes of explanation, it is assumed that media-carrying surface 10 is the circumferential surface 10 of a cylindrical drum (not shown) which extends in a circumferential direction indicated by double-headed arrow 20 and in an axial direction indicated by double-headed arrow 22. Media-carrying surface 10 has a circumference 14 and an axial width 16. As shown in FIG. 2A, the dimensions 14, 16 of media-carrying surface 10 are selected such that dimensions 14, 16 are marginally larger than corresponding dimensions 18, 24 of a maximum-size, standard sheet 12. In the illustrated embodiment, maximum-size, standard sheet 12 has a longer dimension 18 and a shorter dimension 24.

As an example, the maximum-size, standard sheet 12 accommodated by media-carrying surface 10 may be a US E size sheet (i.e. 34×44 inches). In such a case, the drum may be dimensioned such that its circumferential surface 10 has a circumference 14 marginally larger than 44 inches and an axial width 16 marginally larger than 34 inches. As shown in FIG. 2A, maximum-size, standard sheet 12 may then be mounted on the drum such that its longer dimension 18 (44 inches for a US E size sheet) extends circumferentially (i.e. in direction 20) around the drum and its shorter dimension 24 (34 inches for a US E size sheet) extends in the axial direction 22. In alternative embodiments (not shown), maximum-size, standard sheet 12 may be mounted on the circumferential surface of a drum such that its longer dimension 18 extends in the axial direction 22 and its shorter dimension 24 extends in the circumferential direction 20. Such an embodiment would require a drum (not shown) having a circumferential dimension marginally larger than the shorter dimension 24 and an axial dimension marginally larger than the longer dimension 18.

Referring again to FIG. 2A, circumference 14 and axial width 16 of drum surface 10 are preferably marginally larger than the corresponding dimensions 18, 24 of the maximum-size, standard sheet 12 to account for any loading or sheet size inaccuracies and to ensure that the leading and trailing edges of sheet 12 do not overlap when loaded onto media-carrying surface 10. To maintain the highest possible printing throughput, circumference 14 of media-carrying surface 10 should not be made too much larger than the dimensions of the maximum-size, standard sheet 12.

As shown in FIG. 2B, the same media-carrying surface 10 accommodates two standard print media sheets 26A, 26B that are one size smaller than maximum-size, standard sheet 12. For example, if sheet 12 (FIG. 2A) is a US E size sheet, then sheets 26A, 26B are US D size sheets (22×34 inches). Standard print media sheets 26A, 26B are mounted on drum surface 10 such that their longer dimensions are perpendicular to the longer dimension of the maximum-size, standard sheet 12. For example, the longer dimensions 28 of sheets 26A, 26B (34 inches for a US D size sheet) may extend in the axial direction 22 and their shorter dimensions 30 (22 inches for a US D size sheet) may extend side by side in circumferential direction 20.

FIGS. 2A and 2B represent only two possibilities for accommodating different standard sheet(s) 12, 26A, 26B. With media-carrying surface 10 sized as described in the above (i.e. where maximum-size, standard sheet 12 is a US E size sheet and standard sheets 26A, 26B are US D size sheets), those skilled in the art will appreciate that surface 10 could also accommodate four US C size sheets, eight US size B sheets or sixteen US size A sheets.

Maximum-size sheet 12 may be any standard sheet. For example, surface 10 may have dimensions marginally larger than corresponding dimension of a metric A2 size sheet 12. Surface 10 will then accommodate a single A2 size sheet 12 (oriented as shown in FIG. 2A), a pair of metric A3 size sheets 26A, 26B (oriented as shown in FIG. 2B), four metric A4 size sheets, etc.

A number of techniques may be used to secure a print media sheet to a media-carrying surface, such as the circumferential surface of a drum. These techniques include, without limitation: electrostatic attraction, application of vacuum (i.e. pressure below ambient pressure), and mechanical clamping. In preferred embodiments of the invention, print media sheets are secured to the media-carrying surface using vacuum pressure.

FIGS. 2A and 2B show a media-carrying surface 10 that incorporates a vacuum system for securing standard print media sheet(s) 12, 26A, 26B. Again, it is assumed, for the purposes of this explanation, that sheet carrying surface 10 is the circumferential surface 10 of a drum. A plurality of apertures 32 are formed in surface 10. Such apertures 32 may be round (as shown in FIGS. 2A and 2B). Additionally or alternatively, such apertures 32 may be elongated or may have other suitable shapes. A vacuum source (not shown) supplies vacuum to apertures 32, causing a suction force which acts to secure standard print media sheet(s) 12, 26A, 26B to surface 10. Apertures 32 are preferably located, such that when standard sheet(s) 12, 26A, 26B are loaded onto the circumferential surface 10 of the drum, apertures 32 are concentrated around the periphery of the loaded sheet(s) 12, 26A, 26B. This placement of apertures 32 helps to ensure that sheet(s) 12, 26A, 26B stay fixed on the drum when the drum is rotated.

In accordance with the invention, media-carrying surface 10 accommodates a variety of different standard sheet(s) 12, 26A, 26B. As such, a pattern of apertures 32 may be provided in circumferential surface 10 of the drum, such that apertures 32 are located around the perimeters of locations which will accommodate different standard sheet(s) 12, 26A, 26B. For example, as shown in FIGS. 2A and 2B, lines 34A, 34B of apertures 32 may extend in circumferential direction 20 near each of the axial ends 38A, 38B of media-carrying surface 10. In addition, lines 36A, 36B, 36C, 36D of apertures 32 may extend in axial direction 22 at several circumferentially spaced apart locations on surface 10. Preferably (as shown in FIG. 2B), axially oriented lines 36A, 36B, 36C, 36D of apertures 32 are spaced apart in circumferential direction 20, such that when smaller standard sheets 26A, 26B are loaded onto surface 10, the axially oriented lines 36A, 36B, 36C, 36D of apertures 32 are located just inside the longer edges 40A, 40B, 40C, 40D of smaller standard sheets 26A, 26B.

In a case where media-carrying surface 10 is required to accommodate other standard sheets, additional circumferential rings 34 and/or axial rows 36 of apertures 32 may be provided in surface 10.

Other patterns of apertures 32 may be used in accordance with the invention. Preferably, however, the pattern of apertures 32 is selected such that when printing smaller sheets, vacuum pressure is not allowed to escape through any apertures 32 which may remain uncovered by print media.

In some embodiments, mechanical clamps are used to secure print media to the media-carrying surface. In one particular embodiment (not shown), a maximum-size, standard sheet is mounted on the circumferential surface of a media-carrying drum such that the longer dimension of the maximum-size, standard sheet extends in the axial direction and the shorter dimension of the maximum-size, standard sheet extends circumferentially around the drum. The drum of such an embodiment is sized such that the drum's circumferential dimension is marginally larger than the shorter dimension of the maximum-size, standard sheet and the drum's axial dimension is marginally larger than the longer dimension of the maximum-size, standard sheet. In this embodiment, two of the next smaller standard sheets can be mounted with their longer dimensions extending in the circumferential direction and their shorter dimensions extending axially. In this embodiment, the same axially extending clamp can secure both the longer edges of the maximum-size, standard sheet and the shorter edges of the next size smaller standard sheets.

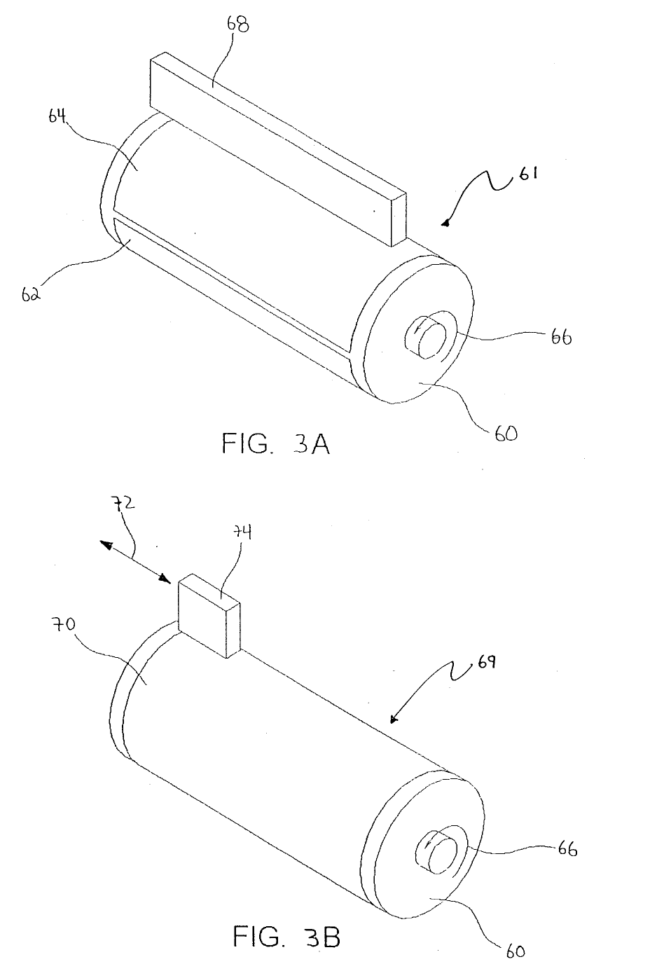

FIG. 3A shows a drum-based inkjet printer 61 in accordance with a particular embodiment of the present invention. Printer 61 comprises a media-carrying drum 60 which is rotatable about its axis in the rotational direction indicated by arrow 66. Two standard print media sheets 62, 64, which may be US D size sheets for example, are simultaneously loaded onto the circumferential surface of drum 60. The dimensions of the media-carrying circumferential surface of drum 60 are marginally larger than the combined corresponding dimensions of the two standard print media sheets 62, 64. The embodiment of FIG. 3A comprises a page-wide array printhead 68 which spans the axial width of drum 60 such that printhead 68 may image both standard sheets 62, 64 as drum 60 rotates in direction 66. The embodiment of FIG. 3A can also accommodate a single larger standard print media sheet (not shown) of the same series (a US E size sheet for example). Alternatively, the embodiment of FIG. 3A can accommodate a larger number of smaller standard print media sheets (not shown) of the same series (four US C size sheets for example).

FIG. 3B shows a drum-based inkjet printer 69 in accordance with another particular embodiment of the invention. Printer 69 comprises a media-carrying drum 60 which is rotatable about its axis in the rotational direction indicated by arrow 66. A single standard print media sheet 70, which may be a US E size sheet for example, is loaded onto the circumferential surface of drum 60. The dimensions of the media-carrying circumferential surface of drum 60 are marginally larger than the corresponding dimensions of the single standard print media sheet 70. The embodiment of FIG. 3B comprises a partial width array printhead 74 which is translated back and forth by a carriage mechanism (not shown) in the directions indicated by double-headed arrow 72. Printhead 74 images standard sheet 70 by translating back and forth (in directions 72) as drum 60 simultaneously rotates (in direction 66). The embodiment of FIG. 3B can also accommodate a pair of smaller standard print media sheets (not shown) of the same series. The smaller sheets may be US D size sheets for example. Similarly, the embodiment of FIG. 3B can also accommodate larger numbers of even smaller standard print media sheets (not shown) of the same series.

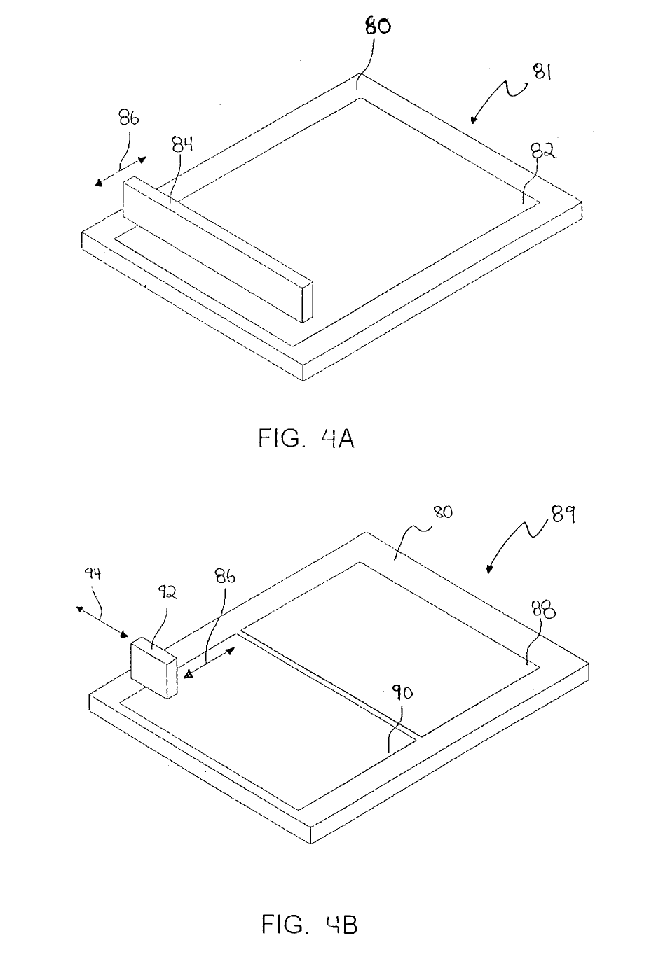

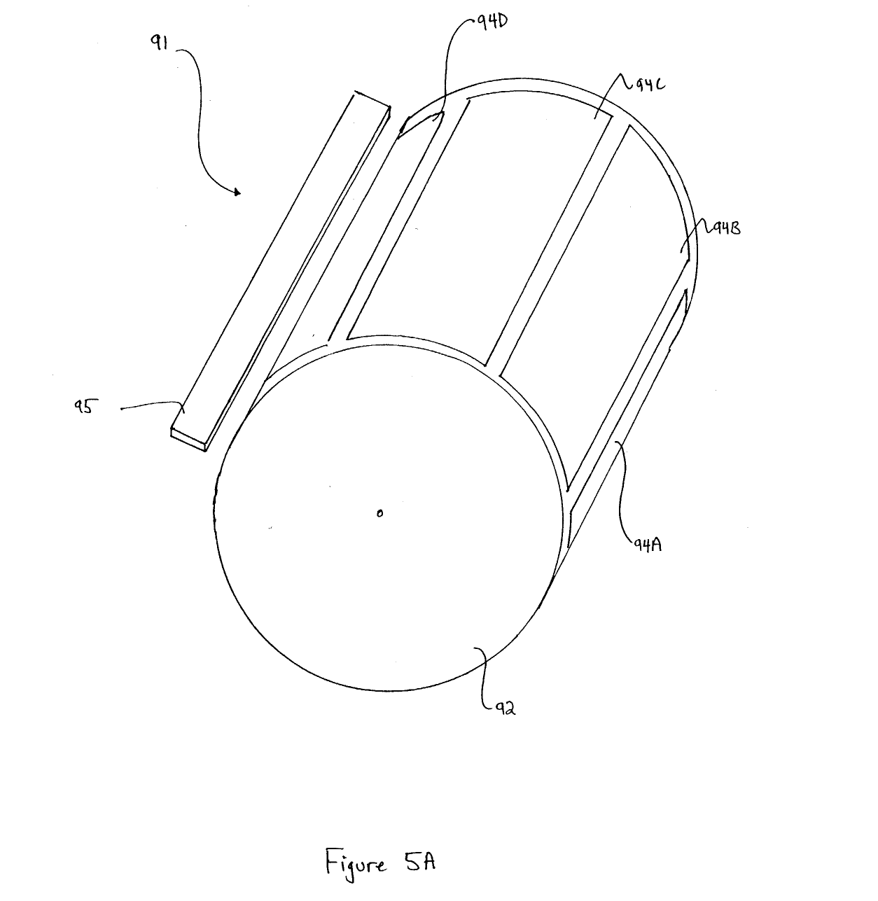

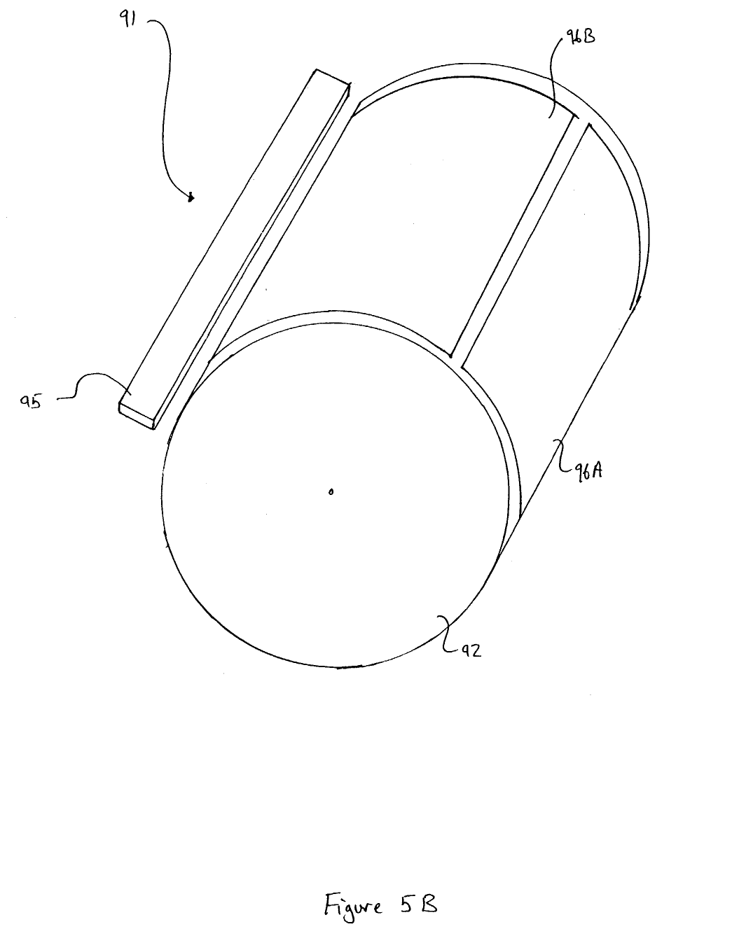

FIG. 4A shows a flatbed printer 81 in accordance with another particular embodiment of the present invention. Printer 81 comprises a flatbed media-carrying surface 80. A single standard print media sheet 82, which may be a US size E sheet for example, is loaded onto media-carrying surface 80. The dimensions of media-carrying surface 80 are marginally larger than the corresponding dimensions of sheet 82. The embodiment of FIG. 4A comprises a page-wide array printhead 84 which spans the width of media-carrying surface 80. In operation, relative motion is introduced between printhead 84 and surface 80, such that printhead 84 moves (relative to surface 80) in one or both of the directions indicated by double-headed arrow 86. Such motion may be created by a carriage mechanism (not shown). Page-wide printhead 84 images standard print media sheet 82 as it moves relative to surface 80 in directions 86. The embodiment of FIG. 4A can also accommodate a pair of smaller standard print media sheets (not shown) of the same series. The smaller sheets may be US D size sheets for example. Similarly, the embodiment of FIG. 4A can also accommodate larger numbers of even smaller standard print media sheets (not shown) of the same series.

FIG. 4B shows a flatbed printer 89 in accordance with another particular embodiment of the invention. Printer 89 comprises a flatbed media-carrying surface 80 which simultaneously accommodates two standard print media sheets 88, 90, which may be US D size sheets for example. The dimensions of media-carrying surface 80 are marginally larger than the combined corresponding dimensions of the two standard print media sheets 88, 90. The embodiment of FIG. 4B comprises a partial width array printhead 92 which is translated back and forth relative to surface 80 by a carriage mechanism (not shown) in the directions indicated by double-headed arrow 94. In operation, relative motion is also introduced between printhead 92 and surface 80, such that printhead 92 also moves (relative to surface 80) in the directions indicated by double-headed arrow 86. Such motion in directions 86 may also be created by a carriage mechanism (not shown). Printhead 92 imparts an image onto standard sheets 88, 90 as it moves relative to surface 80 in directions 86 and 94. The embodiment of FIG. 4B can also accommodate a single larger standard print media sheet (not shown) of the same series (a US E size sheet for example). Alternatively, the embodiment of FIG. 4B can accommodate a larger number of smaller standard print media sheets (not shown) of the same series (four US C size sheets for example).

In all of the above described embodiments of the invention, dead time is minimized and printing throughput is improved by sizing a media-carrying surface such that its dimensions are marginally larger than corresponding dimensions of one (or the combined corresponding dimensions of more than one) standard print media sheet(s) of a particular series and using print media sheets in conjunction with the media-carrying surface which are selected from among the standard sheets of the same series.

In alternative embodiments of the invention, only one of the dimensions of the media-carrying surface is required to be marginally larger than a corresponding dimension of a single print media sheet (or the combined corresponding dimension of a plurality of print media sheets) to achieve the same improvements in printing throughput.

In the case of a partial width array printer, it is only required to size the media-carrying surface to be marginally larger than the corresponding dimension of the print media sheet(s) in the direction orthogonal to the translation of the printhead. For example, in the embodiment depicted in FIG. 3B, it is only necessary that circumferential dimension of the media-carrying surface be marginally larger than the corresponding dimension of the print media sheet(s). In the case of a page wide array printer, it is only necessary that the media-carrying surface be marginally larger than the corresponding dimension of the print media sheet(s) in the direction orthogonal to the direction in which the printhead extends. For example, in the embodiment depicted in FIG. 3A, only the circumferential dimension of the media-carrying surface must be marginally larger than the corresponding dimension of the print media sheet(s).

As discussed above, drum-based inkjet printers such as printers 61, 69 of FIGS. 3A and 3B, involve rotating the drum while simultaneously expelling ink from the inkjet nozzles in the printhead. Printing a complete image often requires a number of revolutions of the drum and a number of passes of the printhead over the same regions of the print media. In each successive printhead pass, ink droplets are typically expelled at positions interleaved with the positions of droplets expelled in previous passes, until the entire image is imparted onto the print media.

Techniques for implementing multiple interleaved passes of the printhead over the print media are well known in the art. Examples of benefits obtained from multiple interleaved printhead passes include improved image resolution, which is achieved by depositing interleaved ink droplets more closely together on successive printhead passes, and minimizing the effect of blocked, clogged or otherwise malfunctioning nozzles, which is achieved by preventing any individual nozzle from printing to immediately adjacent locations on the print media. Interleaving may be achieved, for example, by providing a two-dimensional array of inkjet nozzles in the printhead, wherein successive rows of nozzles in the two-dimensional array are offset from one another in a particular direction.

Another aspect of the invention relates specifically to drum-based printers and involves selecting drum sizes so as to increase the time between successive passes of the inkjet printhead over the same region of print media. If the time between successive passes of the printhead over the same print media region is too small, then expelled ink droplets may not dry between successive printhead passes. In this circumstance, previously expelled ink droplets (i.e. from a previous printhead pass) may still exist in liquid form on the print media surface when the new liquid ink droplets (i.e. from a current printhead pass) are expelled into the same region. In addition, because of the interleaving of ink droplets between successive printhead passes, the previously expelled liquid ink droplets may be located relatively close to the new liquid ink droplets. This results in a greater likelihood that the liquid ink droplets will coalesce, deform in shape or mix with one another, thereby degrading image quality.

The time between successive passes of the inkjet printhead over the same regions of the print media depends, at least in part, on the rotational speed of the drum. Clearly, it is desirable to rotate the drum as fast as possible, because the overall printing throughput depends directly on the rotational speed of the drum. However, the rotational speed of the drum may not be increased indefinitely. Accurate registration of ejected ink droplets cannot be achieved if the linear speed of the print media relative to the printhead (the “drum surface speed”) is too high. With current technology, the drum surface speed has an upper limit of approximately 0.6 m/s.

When the drum surface speed increases above approximately 0.6 m/s, time of flight errors associated with the expulsion of ink droplets tend to become increasingly signficant, causing degradation of image quality. Accordingly, it is often desirable to rotate the drum in a high throughput printer such that the drum surface speed is constant at approximately 0.5 m/s (i.e. somewhat below the speed at which time of flight errors become significant). The maximum drum surface speed may be varied to some degree. However, for the purposes of this explanation, it is assumed that 0.5 m/s is the optimum drum surface speed and that this optimum drum surface speed is constant.

Where drum surface speed is maintained constant, the rotational speed of the drum and, hence, the time between successive passes of the inkjet printhead over the same regions of the print media depend on the circumference of the drum.

As a consequence of this relationship between the circumference and rotational speed of the drum, it is possible to maintain throughput while improving print quality by increasing the circumference of the media-carrying drum to reduce the rotational speed of the drum and correspondingly permit more drying of ink droplets between successive printhead passes. This reduces the risk that liquid ink droplets from successive printhead passes will coalesce or mix with one another and/or deform in shape. For this reason, when a drum is dimensioned to hold one maximum-size, standard sheet it is preferable (as shown in FIG. 2A) to dimension the drum such that the long dimension 18 of the maximum-size, standard sheet 12 extends in the circumferential direction 20.

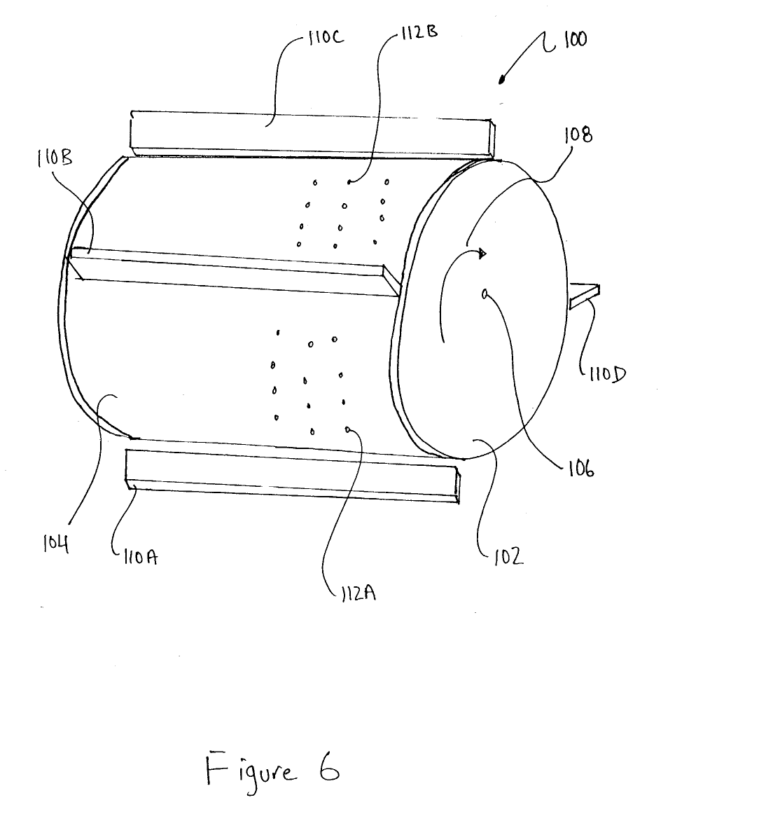

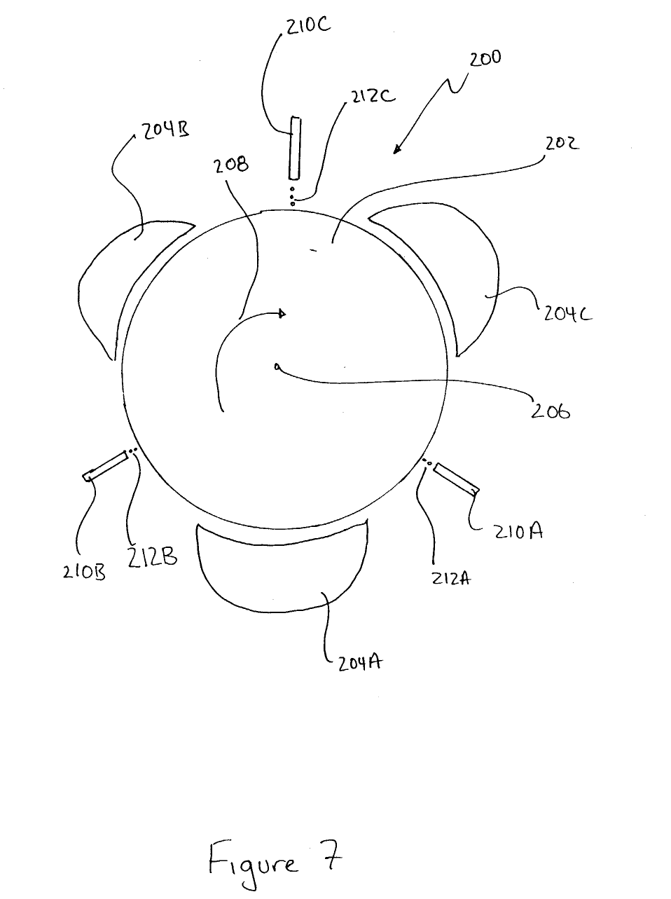

Some embodiments of the invention comprise a media-carrying drum having a very large circumference. For example, it is commercially practical to provide printers having drums with circumferences of up to approximately 275 inches (7 m). FIG. 5A and 5B depict a printer 91 comprising a drum 92 with a relatively large circumference that is marginally larger than 132 inches (3.35 m). In FIG. 5A, drum 92 has 6 US D size sheets 94 mounted on its circumferential surface. In FIG. 5B, drum 92 has 3 US E size sheets mounted on its circumferential surface. The size of the media-carrying surface of drum 92 is selected to have dimensions marginally larger than the combined dimensions of the standard sheets as described above, so that dead time is minimized and a high printing throughput is achieved. For example, a circumference of approximately 136 inches (3.51 m) may be an appropriate size for drum 92.

The relatively large circumference of drum 92 mandates that its rotational speed be relatively low in order to achieve the optimum drum surface speed (i.e. approximately 0.5 m/s). Since the circumference of drum 92 is sized to minimize dead time, print head 95 is almost always printing, such that the relatively low rotational speed of drum 92 does not significantly impact the overall printing throughput. Printer 91 has the additional advantage, however, that the relatively low rotational speed of drum 92 allows ink droplets (not shown in FIGS. 5A and 5B) a longer time to dry between successive passes of printhead 95.

As an example, compare the printing throughput of the printer 61 (FIG. 3A) and printer 91 (FIG. 5A). Assume that printer 61 is loaded with two US D size sheets 62, 64, while printer 91 is loaded with six US D size sheets 94A, 94B, . . . 94F. Assume that the dimensions of the media-carrying surfaces of drums 60 and 92 are both sized to be marginally larger than the corresponding dimensions of their respective print media sheets 62, 64 and 94A, 94B, . . . 94F to minimize dead time as described above. Since the circumference of drum 60 is significantly smaller than that of drum 92, drum 60 will be able to rotate more quickly than drum 92. If a particular printing process requires three interleaved passes to complete, then the images for sheets 62, 64 will be completed by printer 61 just as printer 91 completes its first pass of printhead 95 over the circumference of drum 92. Two more sheets must then be loaded onto drum 60 and imaged by printer 61, whereas printer 91 continues printing by starting to make its second pass. When printer 91 has made three complete passes, then it has imaged all six sheets 94A, 94B, . . . 94F.

It should be appreciated by those skilled in the art, that the time required for printer 91 to complete all three passes (thereby imaging all six sheets 94A, 94B, . . . 94F) may be less than (or not significantly greater than) the time required for printer 61 to image two sheets, load and image the next two sheets and then load and image the final two sheets. This example demonstrates how sizing media-carrying surfaces to have dimensions marginally larger than those of their respective print media sheets to minimize dead time may be used on a drum having relatively large circumference to maintain a high level of printing throughput. The large circumference printer 91 of FIG. 5A has the additional advantage that the relatively low rotational speed of drum 92 allows ink droplets (not shown in FIGS. 5A and 5B) more time to dry between successive passes of printhead 95. Damage to print media may also be reduced by using large circumference printer 91, because ink droplets dry between successive passes of printhead 95, resulting in a lower overall density of liquid ink droplets on the surface of the print media.

When the circumference of a drum is large, a plurality of circumferentially spaced apart printheads may be provided to image the print media. The use of a plurality of circumferentially spaced apart printheads in combination with a drum having a large circumference minimizes the amount of coalescing, mixing and/or deformation of ink droplets, while improving the printing throughput, as is explained in more detail below.

FIG. 6 shows a drum-based inkjet printer 100 comprising: a drum 102, which rotates about its axis 106 in angular direction 108; and a plurality of circumferentially spaced apart inkjet printheads 110A, 110B, 110C, 110D. In one preferred embodiment, each printhead 110 ejects a different color of ink. For example, each printhead 110 may eject ink which is one of black, yellow, cyan and magenta. Alternatively, each printhead 110 may eject multiple ink colors or, for monochromatic printing, all printheads 110 may eject the same ink color. Although the illustrated embodiment comprises four printheads 110A, 110B, 110C, 110D, which are equally circumferentially spaced at 90°, the number and circumferential spacing of printheads 110 may vary. Printheads 110 of FIG. 6 have a page-wide array architecture; however, printer 100 may also be implemented using partial width array printheads (not shown). In the illustrated embodiment, the circumferential surface of drum 102 is shown with a single maximum-size, standard print media sheet 104. Other standard print media sheets (not shown) could be mounted on drum 102. Preferably, the dimensions of drum 102 are sized to be marginally larger than the corresponding dimensions of the print media sheet(s) used thereon to minimize dead time as described above.

In operation, each one of printheads 110 expels ink droplets 112 onto print media sheet 104, while drum 102 rotates in angular direction 108. Because the circumference of drum 102 is relatively large and the rotational speed of drum 102 is correspondingly slow, ink droplets 112A expelled by printhead 110A are at least partially dry prior to the time that they reach printhead 110B. Because ink droplets 112A are at least partially dry before subsequent ink droplets 112B are expelled by printhead 110B, the amount of coalescing or mixing between ink droplets 112A and 112B and/or any deformation of ink droplets 112A, 112B is minimal. In a similar manner, ink droplets 112B, 112C, 112D are respectively expelled by printheads 110B, 110C, 110D and are at least partially dry prior to the time that they reach their respective subsequent printheads 110C, 110D, 110A.

When ink droplets 112 are at least partially dried between successive expulsions of liquid ink, the risk of ink droplets 112 coalescing, mixing and/or deforming in shape is reduced. Additionally, because each of the plurality of printheads 110 expels ink at the same time, the printing throughput of printer 100 is improved. In the illustrated embodiment, the four printheads 110A, 110B, 110C, 110D may provide up to a four-fold improvement in printing throughput. Furthermore, damage to print media sheet 104 may also be reduced because ink droplets 112 at least partially dry between successive expulsions of liquid ink, resulting in a lower overall density of ink in liquid form on the print media surface.

The drying time required for different types of ink and different types of media may vary. Those skilled in the art will appreciate that the number of printheads 110, the circumferential separation of printheads 110 and the circumference and rotational speed of drum 102 may be selected such that ink droplets 112 expelled onto print media 104 will be at least partially dry prior to the time that subsequent ink droplets 112 are expelled into the same region.

FIG. 7 shows an end view of a drum-based printer 200 comprising a drum 202, which rotates about its axis 206 in angular direction 208. Printer 200 also comprises a plurality of circumferentially spaced apart inkjet printheads 210A, 210B, 210C, and a plurality of drying devices 204A, 204B, 204C, each of which is positioned between a pair of printheads 210. In one preferred embodiment, each printhead 210 ejects ink droplets 212 of a different color. Alternatively, each printhead 210 may eject multiple ink colors or, for monochromatic printing, all printheads 210 may eject the same ink color. Although the illustrated embodiment comprises three printheads 210A, 210B, 210C, which are equally circumferentially spaced at 1200 intervals, the number and circumferential spacing of printheads 210 may vary. Printheads 210 shown in FIG. 7 have a page-wide array architecture; however, printer 200 may also be implemented using partial width array printheads (not shown). Preferably, the dimensions of drum 202 are sized to be marginally larger than the corresponding dimensions of the print media sheet(s) used thereon to minimize dead time as described above.

The preferred nature of drying devices 204 depends on the type of ink used. For example, if printheads 210 eject UV-curable ink droplets 212, then drying devices 204 may comprise sources of ultraviolet radiation. Additionally or alternatively for heat-curable, water-based, oil-based or solvent-based inks, drying devices 204 may comprise sources of heat, pressurized air and/or infrared radiation. Drying devices 204 may also be means of reducing atmospheric pressure acting on ink droplets 212, such as a vacuum source.

Preferably, drying devices extend over a maximum possible amount of the circumference of the drum (i.e. to occupy substantially all of the circumference where there are no printheads). In this manner, a maximum amount of drying may occur between each successive expulsion of ink droplets or a desired drying effect may be achieved at lower drying intensity.

In operation, each one of printheads 210 expels ink droplets 212 onto the print media surface (not shown), while drum 202 rotates in angular direction 208. After printhead 210A expels ink droplets 212A onto the surface of the print media, the rotation of drum 202 causes ink droplets 212A to rotate past drying device 204A. Drying device 204 accelerates the drying of ink droplets 212A, such that ink droplets 212A are at least partially dry prior to the time that they reach subsequent printhead 210B. Because ink droplets 212A are at least partially dry before subsequent ink droplets 212B are expelled by printhead 210B, the amount of coalescing or mixing between ink droplets 212A and 212B and/or any deformation of ink droplets 212A, 212B is minimal. In a similar manner, ink droplets 212B, 212C are respectively expelled by printheads 210B, 210C and are subjected to drying treatment by drying devices 204B, 204C, such that ink droplets 212B, 212C are at least partially dry prior to the time that they reach their respective subsequent printheads 210C, 210A.

When ink droplets 212 are at least partially dried between successive expulsions of liquid ink, the risk of ink droplets 212 coalescing, mixing and/or deforming in shape is reduced. Additionally, because each of the plurality of printheads 210 expels ink at the same time, the printing throughput of printer 200 is improved. In the illustrated embodiment, the three printheads 210A, 210B, 210C may provide up to a three-fold improvement in printing throughput. Furthermore, damage to the print media sheet may also be reduced because ink droplets 212 at least partially dry between successive expulsions of liquid ink, resulting in a lower overall density of ink in liquid form on the print media surface.

The addition of drying devices 204 provides an extra parameter for use in the design of an inkjet printer. More specifically, drying devices 204 decrease the time required between successive applications of ink droplets 212, such that printer 200 may be implemented with a drum 202 having a faster rotational speed and a correspondingly smaller circumference. Drying devices 204 may also allow a printer with a given sized drum to be designed with a larger number of printheads, such that printing throughput may be improved.

The drying time required for different types of ink and different types of print media may vary. In addition, the effect and intensity of drying devices 204 may also vary. Those skilled in the art will appreciate that the number of printheads 210, the circumferential separation of printheads 210, the circumference and rotational speed of drum 202 and the type and intensity of drying devices 204 may be selected appropriately, such that ink droplets 212 expelled onto the print media will be at least partially dry prior to the time that subsequent ink droplets 212 are expelled into the same region.

Some embodiments of the invention provide printing methods which comprise: maintaining a surface speed of a rotating media-carrying drum in excess of 0.35 m/s; applying first ink droplets from a first printhead; and allowing the drum to carry the ink droplets to a next printhead (which may be the first printhead). The method comprises drying the ink droplets as they travel between the first printhead and the next printhead for a time in excess of 0.5 seconds and preferably in excess of 0.8 seconds.

Some embodiments of the invention provide inkjet printing apparatus comprising: a rotatable media-carrying drum; a drive connected to rotate the drum so that points on a circumferential surface of the drum travel at a printing surface speed of at least 0.35 m/s; and one or more printheads located adjacent to the circumferential surface of the drum, wherein the drum has a circumference and the one or more printheads are located about the circumferential surface such that while the drum is rotating at the printing surface speed, any point on the circumferential surface takes at least 0.5 seconds to travel between adjacent ones of the one or more printheads.

Some embodiments of the invention provide inkjet printing apparatus comprising: a media-carrying surface; and means for securing print media to the media-carrying surface. The means for securing print media to the media-carrying surface are configured to secure an integral number of a larger standard print media sheet to the media-carrying surface such that a longer dimension of each larger standard print media sheet extends in a first direction and a shorter dimension of each larger standard print media sheet extends in a second orthogonal direction. The means for securing print media to the media-carrying surface are also configured to secure twice the integral number of a smaller standard print media sheet to the media-carrying surface such that a shorter dimension of each smaller standard print media sheet extends in the first direction and a longer dimension of each smaller standard print media sheet extends in the second orthogonal direction.

Some embodiments of the invention provide inkjet printing methods which comprise: mounting three or more print media sheets circumferentially adjacent to one another on a circumferential surface of a rotatable drum; and ejecting ink droplets from an inkjet printhead while rotating the drum to carry the print media sheets sequentially past the inkjet printhead. The print media sheets each have a first dimension oriented circumferentially on the drum. The circumference of the drum is marginally larger than a sum of the first dimensions of the print media sheets.

Some embodiments of the invention relate to inkjet printers comprising an inkjet printhead located adjacent to a rotatable media-carrying drum, the drum having a circumference and an axial width wherein the width is within the range of either:

(a) n\sqrt{2} circumference±5%; or

$$\begin{matrix}n \sqrt{2} circumference \pm 5 \% ; or & ( a ) \\ n \frac{1}{\sqrt{2}} circumference \pm 5 \% & ( b ) \end{matrix}$$

where n is an integer.

As will be apparent to those skilled in the art in the light of the foregoing disclosure, many alterations and modifications are possible in the practice of this invention without departing from the spirit or scope thereof. For example:

A printer may image large sheets of print media which may be subsequently cut or folded in a further operation if a smaller page is required.

The description presented above alludes to the concept of an ink droplet “drying” on a print media surface. The concept of drying should be interpreted in a broad sense. In accordance with the invention drying may incorporate a wide variety of processes, including, without limitation: absorption of ink droplets into the print media, cross-linking of hydrocarbons in oil-based ink droplets, curing of curable liquid ink droplets and/or evaporation of solvents from liquid ink droplets.

Drying may also include removing saturated air from a region surrounding ink droplets. For example, solvent-based inks may require the solvent to evaporate. Drying by blowing pressurized gas into the vicinity of the ink droplets may remove solvent-saturated air from a vicinity of the ink droplets, allowing the remaining solvent to evaporate faster.

Drying may also include partial drying. For example, UV-curable inks may only require a “skin” to be formed over the ink droplet, so that the dot shape is not compromised.

In addition to using drying devices 204 as shown in FIG. 7, any of the embodiments of the invention may incorporate a heated drum or, more generally, a heated media-carrying surface. A heated media-carrying surface may assist in drying ink droplets expelled thereon.

The use of drying devices is not limited to printers having multiple printheads. Drying devices may be used in conjunction with printers having a single printhead. In single printhead embodiments, drying device(s) may extend everywhere over the circumference of the drum (except in the location of the printhead), such that a maximum amount of drying may occur between each printhead pass or a desired drying effect may be achieved at lower drying intensity.

Any of the embodiments described above may also be implemented on flatbed inkjet printers.

For printers having a page-wide array architecture, the axial width of a drum may also be increased to increase printing throughput.

The invention may be used in conjunction with specially formulated inkjet paper, which may help to prevent coalescing of liquid ink droplets and paper damage from liquid ink.

Accordingly, the scope of the invention is to be construed in accordance with the substance defined by the following claims.

What is claimed is:

1. An inkjet printer comprising an inkjet printhead, a media-carrying surface and a mechanism for moving the printhead and the media-carrying surface relative to one another, the media-carrying surface having at least one dimension that is marginally larger than a corresponding dimension of one (or a combined corresponding dimension of more than one) standard print media sheet.

2. The printer of claim 1, wherein the media-carrying surface comprises a circumferential surface of a substantially cylindrical drum.

3. The printer of claim 2, wherein an axial width of the substantially cylindrical drum is greater than the circumference of the substantially cylindrical drum.

4. The printer of claim 3, wherein the at least one dimension of the media-carrying surface is the axial width of the substantially cylindrical drum.

5. The printer of claim 2, wherein the circumference of the substantially cylindrical drum is greater than an axial width of the substantially cylindrical drum.

6. The printer of claim 5, wherein the at least one dimension of the media-carrying surface is the circumference of the substantially cylindrical drum.

7. The printer of claim 6 comprising a drying device located adjacent to the circumferential surface.

8. The printer of claim 7 wherein the drying device comprises at least one of: a source of ultraviolet radiation, a source of infrared radiation, a source of heat, a source of pressurized gas and a means for reducing localized atmospheric pressure.

9. The printer of claim 6 comprising a plurality of inkjet printheads located adjacent to the circumferential surface at circumferentially spaced apart intervals.

10. The printer of claim 9 comprising a plurality of drying devices located adjacent to the circumferential surface at circumferentially spaced apart intervals between the inkjet printheads.

11. The printer of claim 10, wherein each drying device comprises at least one of: a source of ultraviolet radiation, a source of infrared radiation, a source of heat, a source of pressurized gas and a means for reducing localized atmospheric pressure.

12. The printer of claim 2, wherein the circumferential surface is heated.

13. The printer of claim 1, wherein the media-carrying surface is a substantially flat surface.

14. The printer of claim 6, wherein the at least one dimension of the media-carrying surface is larger than the corresponding dimension of one (or the combined corresponding dimension of more than one) standard print media sheet by not more than 2%.

15. The printer of claim 6, wherein the at least one dimension of the media-carrying surface is larger than the corresponding dimension of one (on the combined corresponding dimension of more than one) standard print media sheet by not more than 5%.

16. The printer of claim 6, wherein the at least one dimension of the media-carrying surface is larger than the corresponding dimension of one (on the combined corresponding dimension of more than one) standard print media sheet by not more than 10%.

17. The printer of claim 2, wherein the substantially cylindrical drum has a circumference and an axial width, wherein the axial width is within the range of one of:
(a) n\sqrt{2} circumference±5%; and
$$\begin{matrix}n \sqrt{2} circumference \pm 5 \% ; and & ( a ) \\ n \frac{1}{\sqrt{2}} circumference \pm 5 \% & ( b ) \end{matrix}$$
where n is an integer.

18. The printer of claim 1 comprising means for securing print media to the media-carrying surface configured to secure an integral number of a larger standard print media sheet to the media-carrying surface such that a longer dimension of each larger standard print media sheet extends in a first direction and a shorter dimension of each larger standard print media sheet extends in a second orthogonal direction and to secure twice the integral number of a smaller standard print media sheet to the media-carrying surface such that a shorter dimension of each smaller standard print media sheet extends in the first direction and a longer dimension of each smaller standard print media sheet extends in the second orthogonal direction.

19. An inkjet printer comprising:
a substantially cylindrical drum having a media-carrying circumferential surface, the drum rotatable about its axis;
one or more printheads located adjacent to the circumferential surface at one or more circumferentially spaced apart positions, each printhead comprising a plurality of inkjet nozzles directed towards the circumferential surface
wherein when the drum is rotated at a selected rotational speed and first ink droplets are ejected from the inkjet nozzles of a first one of the one or more printheads into a first region of a print media surface, the ink droplets at least partially dry on the print media surface prior to ink droplets being ejected from the inkjet nozzles of a circumferentially adjacent one of the one or more printheads into the first region.

20. The printer of claim 19 comprising a drive connected to rotate the drum at the selected rotational speed so that points on a circumferential surface of the drum travel at a printing surface speed of at least 0.35 m/s.

21. The printer of claim 20 wherein the drum has a circumference and the one or more printheads are located such that while the drum is rotating at the selected rotational speed, any point on the circumferential surface takes at least 0.5 seconds to travel between the first one of the one or more printheads and the circumferentially adjacent one of the one or more printheads.

22. A method of inkjet printing, the method comprising:
providing a media-carrying surface having at least one dimension that is marginally larger than a corresponding dimension of one (or a combined corresponding dimension of more than one) standard print media sheet;
securing an integer number of standard print media sheets of a particular series on the media-carrying surface in a first orientation; and
imaging the standard print media sheets by ejecting ink droplets thereon.

23. The method of claim 22 comprising:
removing the one or more standard print media sheets from the media-carrying surface;
securing twice the integer number of smaller sized standard print media sheets of the particular series on the media-carrying surface in a second orientation that is orthogonal to the first orientation; and
imaging the smaller sized standard print media sheets by ejecting ink droplets thereon.

24. The method of claim 22 wherein the media-carrying surface comprises a circumferential surface of a substantially cylindrical drum and the method comprises revolving the substantially cylindrical drum about its axis.

25. The method of claim 24, wherein the at least one dimension of the media-carrying surface is a circumference of the substantially cylindrical drum.

26. The method of claim 25 comprising drying the ink droplets on the standard print media sheets.

27. The method of claim 26, wherein drying the ink droplets comprises at least one of:
(a) irradiating the ink droplets with ultraviolet radiation;
(b) irradiating the ink droplets with infrared radiation;
(c) heating the ink droplets;
(d) directing pressurized gas at the ink droplets; and
(e) reducing atmospheric pressure in a region of ink droplets.

28. An inkjet printing method comprising:
mounting three or more print media sheets circumferentially adjacent to one another on a circumferential surface of a rotatable drum; and
ejecting ink droplets from an inkjet printhead while rotating the drum to carry the print media sheets sequentially past the inkjet printhead,
wherein the print media sheets each have a first dimension oriented circumferentially on the drum and a circumference of the drum is marginally larger than a sum of the first dimensions of the print media sheets.

29. The method of claim 28, wherein the print media sheets are standard print media sheets.

30. The method of claim 29 wherein rotating the drum to carry the print media sheets past the inkjet printhead comprises making multiple passes between the print media sheets and the inkjet printhead.

31. The method of claim 30 wherein making multiple passes between the print media sheets and the inkjet printhead comprises ejecting ink droplets into interleaved positions on each pass.

32. A method of inkjet printing comprising:
securing a print medium to a media-carrying circumferential surface of a substantially cylindrical drum;
rotating the substantially cylindrical drum about its axis;
ejecting ink droplets from one or more printheads onto the print medium, the one or more printheads located adjacent to the circumferential surface at one or more circumferentially spaced apart positions; and
allowing the ink droplets ejected from a particular one of the one or more printheads into a particular region on the print medium to at least partially dry prior to ejecting ink droplets from a circumferentially adjacent one of the one or more printheads into the particular region.

33. The method of claim 32 wherein rotating the substantially circular drum about its axis comprises maintaining a surface speed of the circumferential surface in excess of 0.35 m/s.

34. The method of claim 33, wherein allowing ink droplets ejected from the particular one of the one or more printheads into the particular region on the print medium to at least partially dry comprises actively drying the ink droplets as they travel between the particular one of the one or more printheads and the circumferentially adjacent one of the one or more printheads for a time in excess of 0.5 seconds.
